(19) United States
(12) Patent Application Publication
(10) Pub. No.: US 2025/0164708 A1
(43) Pub. Date: May 22, 2025

(54) ELECTRONIC DEVICE FOR PROVIDING AUGMENTED REALITY AND METHOD BY WHICH ELECTRONIC DEVICE COMPENSATES FOR IMAGE

(71) Applicant: Samsung Electronics Co., Ltd., Suwon-si (KR)

(72) Inventors: Chanhyung YOO, Suwon-si (KR); Nari KIM, Suwon-si (KR); Kyongtae PARK, Suwon-si (KR); Hoyoung JUNG, Suwon-si (KR)

(21) Appl. No.: 19/032,826

(22) Filed: Jan. 21, 2025

Related U.S. Application Data
(63) Continuation of application No. PCT/KR2023/005644, filed on Apr. 26, 2023.

(30) Foreign Application Priority Data
Jul. 22, 2022 (KR) 10-2022-0091141
Aug. 29, 2022 (KR) 10-2022-0108600

(51) Int. Cl. G02B 6/42; G02B 27/01

(52) U.S. Cl. CPC G02B 6/4206; G02B 27/0172; G02B 2027/011; G02B 2027/0178

(57) ABSTRACT

An electronic device according to various embodiments of the present disclosure may comprise: a display configured to output light of an augmented reality image; a wave guide configured to transmit the light output from the display toward a user's eyes; at least one alignment coupler disposed on an optical path formed by the wave guide to diffract at least a part of incident light at a specified angle; a photodetector configured to detect at least a part of the light diffracted by the alignment coupler; and at least one processor, comprising processing circuitry, operatively connected to the display and the photodetector.

### CROSS-REFERENCE TO RELATED APPLICATIONS

This application is a continuation of International Application No. PCT/KR2023/005644 designating the United States, filed on Apr. 26, 2023, in the Korean Intellectual Property Receiving Office and claiming priority to Korean Patent Application Nos. 10-2022-0091141, filed on Jul. 22, 2022, and 10-2022-0108600, filed on Aug. 29, 2022, in the Korean Intellectual Property Office, the disclosures of each of which are incorporated by reference herein in their entireties.

### BACKGROUND

### Field

The disclosure relates to an electronic device and, for example, to an electronic device capable of providing an augmented reality image and a method for compensating for an augmented reality image by the electronic device.

### Description of Related Art

Augmented reality (AR) refers to a computer graphics technology that displays a virtual augmented reality image by overlaying the image with real-world information, so that the augmented reality image appears to a user as if it were an object in a real environment. Augmented reality technology may be provided by a wearable electronic device (hereinafter, an electronic device) that a user wears on his or her face, such as AR glasses or a head mounted display (HMD).

The electronic device may include an optical structure for allowing light output from a display including an augmented reality image to appear to overlap with real-world information in a direction of a user's gaze. For example, the electronic device may include a wave guide for guiding light toward the user's eyes. The wave guide may diffract light from the display through at least one diffractive element and output the light toward the user's eyes, and the display and the wave guide need to be configured so that their positions are aligned with an eyepiece through which the user perceives real-world information.

Depending on a manufacturing process and/or a usage state of an electronic device, a gap or tilt may occur between components of the electronic device due to various causes, and accordingly, a path of light output from a display and traveling to a user's eyes may be partially misaligned. As such, in a case where an optical path in an optical structure is misaligned, an error may occur in a position of an augmented reality image that is required to be displayed at a specific location from the user's actual line of sight, unlike a designed location.

### SUMMARY

According to various example embodiments of the disclosure, an electronic device may include: a display configured to output light including an augmented reality image; a wave guide configured to transmit light output from the display toward a user's eyes; at least one alignment coupler disposed on an optical path formed by the wave guide, and configured to diffract at least a part of incident light at a specified angle; a photodetector configured to detect at least a part of light diffracted by the alignment coupler; and at least one processor, comprising processing circuitry, operatively connected to the display and the photodetector.

According to various example embodiments, at least one processor, individually and/or collectively, may be configured to identify information related to light detected by the photodetector.

According to various example embodiments, at least one processor, individually and/or collectively, may be configured to determine a position error of an augmented reality image incident on the user's eyes, based on the identified information.

According to various example embodiments, at least one processor, individually and/or collectively, may be configured to compensate for a position of light incident on the wave guide from the display in order to compensate for the determined position error.

An augmented reality image compensation method of an electronic device according to various example embodiments may include: identifying information related to light detected by a photodetector, determining a position error of an augmented reality image incident on a user's eyes, based on the identified information, and compensating for a position of light incident on a wave guide from a display to compensate for the determined position error.

According to various example embodiments of the disclosure, in a wave guide-based augmented reality electronic device, an electronic device capable of measuring and compensating for a position error of an augmented reality image which may occur due to various causes, and an image compensation method of the electronic device may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment, according to various embodiments;

FIG. 2 is a perspective view illustrating an example configuration of an electronic device according to various embodiments;

FIG. 3 is a diagram illustrating an example structure of an optical system including a wave guide of an electronic device according to various embodiments;

FIG. 4 is a block diagram illustrating an example configuration of an electronic device according to various embodiments;

FIGS. 5A, 5B, and 5C are diagrams illustrating example arrangement structures of a wave guide, an alignment coupler, and a photodetector of an electronic device according to various embodiments;

FIGS. 6A and 6B are diagrams illustrating light detected by a photodetector according to various embodiments;

FIG. 7 is a diagram illustrating a photodetector of an electronic device according to various embodiments;

FIGS. 8A and 8B are diagrams illustrating an optical path before and after compensation of a position of light incident from a display in an electronic device according to various embodiments;

FIG. 9 is a diagram illustrating an example two-dimensional exit-pupil expanding (EPE) structure of an electronic device according to various embodiments; and

FIG. 10 is a flowchart illustrating an example augmented reality image compensation method of an electronic device according to various embodiments.

### DETAILED DESCRIPTION

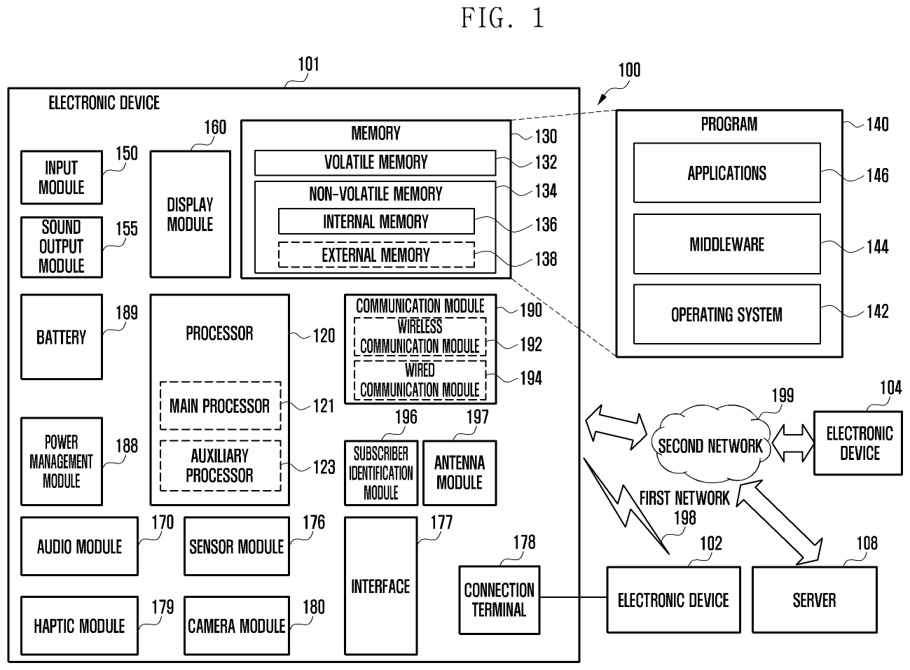

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate 30 server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or ay combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

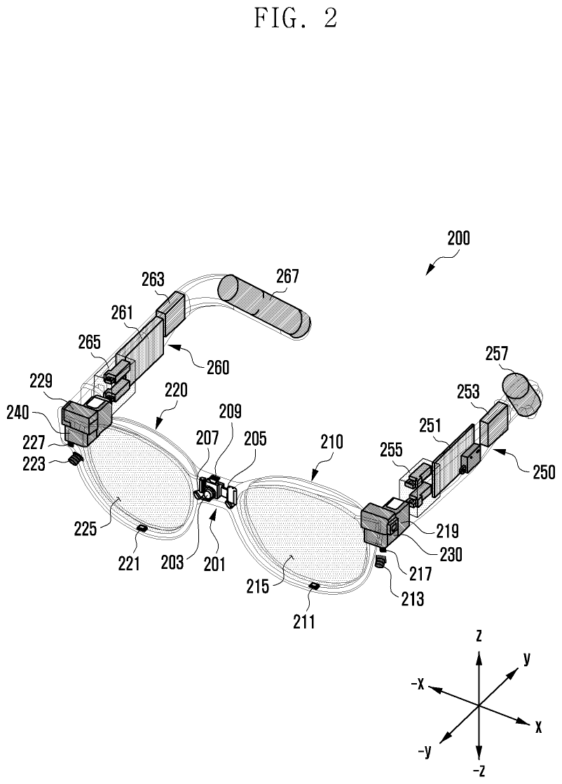

FIG. 2 is a perspective view illustrating an example i configuration of an electronic device according to various embodiments.

FIG. 2 illustrates a structure of a wearable electronic device in the form of glasses (e.g., AR glasses or smart glasses), but the electronic device of the disclosure may be implemented as another type of electronic device which can be worn by a user. An electronic device 200 may further include at least a part of the configuration and/or functions of the electronic device 101 of FIG. 1.

Referring to FIG. 2, the electronic device 200 according to various embodiments may include a bridge 201, a first rim 210, a second rim 220, a first end piece 230, a second end piece 240, a first temple 250, and/or a second temple 260.

According to an embodiment, the bridge 201 may connect the first rim 210 and the second rim 220. The bridge 201 may be positioned over the nose of a user when the user wears the electronic device 200. The bridge 201 may separate the first rim 210 and the second rim 220 with reference to the nose of the user.

According to various embodiments, the bridge 201 may include a camera module 203, a first gaze tracking camera 205, a second gaze tracking camera 207, and/or an audio module 209.

According to various embodiments, the camera module 203 (e.g., the camera module 180 of FIG. 1) may photograph the front (e.g., the −y-axis direction) of the user and obtain image data. The camera module 203 may capture an image corresponding to a field of view (FOV) of the user or measure a distance to a subject. The camera module 203 may include an RGB camera, a high resolution (HR) camera, and/or a photo video (PV) camera. The camera module 203 may include a color camera having an auto focus (AF) function and an optical image stabilization (OIS) function in order to obtain a high-quality image.

According to various embodiments, the first gaze tracking camera 205 and the second gaze tracking camera 207 may identify the gaze of the user. The first gaze tracking camera 205 and the second gaze tracking camera 207 may photograph pupils of the user in a direction opposite to a photographing direction of the camera module 203. For example, the first gaze tracking camera 205 may partially photograph the left eye of the user, and the second gaze tracking camera 207 may partially photograph the right eye of the user. The first gaze tracking camera 205 and the second gaze tracking camera 207 may detect the pupils (e.g., the left and right eyes) of the user and track a gaze direction. The tracked gaze direction may be used to move the center of a virtual image including a virtual object to correspond to the gaze direction. The first gaze tracking camera 205 and/or the second gaze tracking camera 207 may track the gaze of the user using, for example, at least one of an electro-oculography or electrooculogram (EOG) sensor, a coil system, a dual Purkinje system, bright pupil systems, or dark pupil systems.

According to various embodiments, the audio module 209 (e.g., the audio module 170 of FIG. 1) may be disposed between the first gaze tracking camera 205 and the second gaze tracking camera 207. The audio module 209 may convert a voice of the user into an electrical signal or convert an electrical signal into sound. The audio module 209 may include a microphone.

According to an embodiment, the first rim 210 and the second rim 220 may configure a frame (e.g., an AR glasses frame) of the electronic device 200. The first rim 210 may be disposed in a first direction (e.g., the x-axis direction) of the bridge 201. The first rim 210 may be disposed at a position corresponding to the left eye of the user. The second rim 220 may be disposed in a second direction (e.g., the −x-axis direction) of the bridge 201, which is opposite to the first direction (e.g., the x-axis direction). The second rim 220 may be disposed at a position corresponding to the right eye of the user. The first rim 210 and the second rim 220 may be formed of a metal material and/or a non-conductive material (e.g., a polymer).

According to various embodiments, the first rim 210 may surround and support at least a part of a first glass member 215 disposed on the inner circumferential surface thereof. The first glass member 215 may be positioned in front of the left eye of the user. The second rim 220 may surround and support at least a part of a second glass member 225 disposed on the inner circumferential surface thereof. The second glass member 225 may be positioned in front of the right eye of the user. The user of the electronic device 200 may view a foreground (e.g., a real image or real-world information) with respect to an external object through the first glass member 215 and the second glass member 225. The electronic device 200 may implement augmented reality by overlappingly displaying a virtual image on real-world information including an external object.

According to various embodiments, the first glass member 215 and the second glass member 225 may include a projection type transparent display. Each of the first glass member 215 and the second glass member 225 may form a reflective surface as a transparent plate (or transparent screen), and an image generated by the electronic device 200 may be reflected (e.g., total internal reflection) through a reflective surface, and incident on the left and right eyes of the user.

According to various embodiments, the first glass member 215 may include a wave guide (or optical wave guide) configured to transmit light generated from a light source of the electronic device 200 to the left eye of the user. For example, the wave guide may be formed of glass, plastic, or a polymer material, and may include a nanopattern (e.g., a polygonal or curve-shaped grating structure or a mesh structure) formed on the inside or surface of the first glass member 215. The wave guide may include at least one of at least one diffractive element (e.g., a diffractive optical element (DOE) or a holographic optical element (HOE)) or a reflective element (e.g., a reflective mirror). The wave guide may guide display light emitted from a light source to the eyes of the user using at least one diffractive element or reflective element included in the wave guide. In various embodiments, the diffractive element may include an input/output optical member, and the reflective element may include total internal reflection (TIR). For example, the optical path of the light emitted from a light source may be induced to a wave guide through an input optical member (e.g., an in-coupler) and the light traveling inside the wave guide may be guided toward the user's eyes through an output optical element (e.g., an out-coupler).

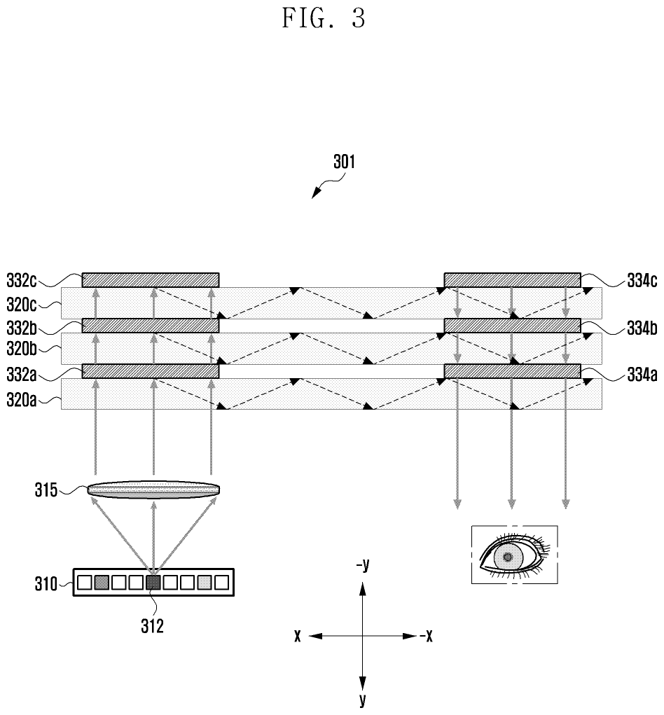

The second glass member 225 may be implemented in substantially the same manner as the first glass member 215. An optical path formed through the wave guide of the first glass member 215 and the second glass member 225 will be described in more detail with reference to FIG. 3.

According to various embodiments, the first glass member 215 and the second glass member 225 may include, for example, a liquid crystal display (LCD), a digital mirror device (DMD), a liquid crystal on silicon (LCoS), a light-emitting diode (LED) on silicon (LEDoS), an organic light-emitting diode (OLED), an organic light-emitting diode on silicon (OLEDoS), or a micro light-emitting diode (micro LED). Although not shown, when the first glass member 215 and the second glass member 225 are made of one of the liquid crystal display, the digital mirror device, or the liquid crystal on silicon, the electronic device 200 may include a light source which radiates light to screen output areas of the first glass member 215 and the second glass member 225. In an embodiment, when the first glass member 215 and the second glass member 225 may generate light by themselves, for example, when the first glass member and the second glass member are made of either the organic light-emitting diode or the micro LED, the electronic device 200 may provide a virtual image having good quality to the user even without a separate light source.

According to various embodiments, the first rim 210 may include a first microphone 211, a first recognition camera 213, a first light-emitting device 217, and/or a first display module 219. The second rim 220 may include a second microphone 221, a second recognition camera 223, a second light-emitting device 227, and/or a second display module 229.

In various embodiments, the first light-emitting device 217 and the first display module 219 may be included in the first end piece 230, and the second light-emitting device 227 and the second display module 229 may be included in the second end piece 240.

According to various embodiments, the first microphone 211 and/or the second microphone 221 may receive a voice of the user of the electronic device 200 and convert the voice into an electrical signal.

According to various embodiments, the first recognition camera 213 and/or the second recognition camera 223 may recognize a space around the electronic device 200. The first recognition camera 213 and/or the second recognition camera 223 may detect a gesture of the user within a predetermined (e.g., specified) distance (e.g., a predetermined space) of the electronic device 200. The first recognition camera 213 and/or the second recognition camera 223 may include a global shutter (GS) camera in which a rolling shutter (RS) phenomenon may be reduced, in order to detect and track a rapid hand motion of the user and/or a fine movement of the user's finger. The electronic device 200 may detect an eye corresponding to the dominant eye and/or the non-dominant eye among the left eye and/or the right eye of the user using the first gaze tracking camera 205, the second gaze tracking camera 207, the first recognition camera 213, and/or the second recognition camera 223. For example, the electronic device 200 may detect an eye corresponding to the dominant eye and/or the non-dominant eye, based on the direction of the gaze of the user with respect to an external object or a virtual object.

According to various embodiments, the first light-emitting device 217 and/or the second light-emitting device 227 may emit light to increase the accuracy of the camera module 203, the first gaze tracking camera 205, the second gaze tracking camera 207, the first recognition camera 213, and/or the second recognition camera 223. The first light-emitting device 217 and/or the second light-emitting device 227 may be used as an auxiliary means for increasing the accuracy when photographing the pupils of the user using the first gaze tracking camera 205 and/or the second gaze tracking camera 207. When a gesture of the user is photographed using the first recognition camera 213 and/or the second recognition camera 223, the first light-emitting device 217 and/or the second light-emitting device 227 may be used as an auxiliary means when it is not easy to detect an object (e.g., a subject) to be photographed due to reflected light and mixing of various light sources or a dark environment. The first light-emitting device 217 and/or the second light-emitting device 227 may include, for example, an LED, an IR LED, or a xenon lamp.

According to various embodiments, the first display module 219 and/or the second display module 229 may emit light and transmit the light to the left eye and/or the right eye of the user using the first glass member 215 and/or the second glass member 225. The first glass member 215 and/or the second glass member 225 may display various image information using light emitted through the first display module 219 and/or the second display module 229. The electronic device 200 may overlap and display an image emitted through the first display module 219 and/or the second display module 229 and the foreground with respect to an external object, through the first glass member 215 and/or the second glass member 225.

According to an embodiment, the first end piece 230 may be coupled to a part (e.g., the x-axis direction) of the first rim 210. The second end piece 240 may be coupled to a part (e.g., the −x-axis direction) of the second rim 220. In various embodiments, the first light-emitting device 217 and the first display module 219 may be included in the first end piece 230. The second light-emitting device 227 and the second display module 229 may be included in the second end piece 240.

According to various embodiments, the first end piece 230 may connect the first rim 210 and the first temple 250. The second end piece 240 may connect the second rim 220 and the second temple 260.

According to an embodiment, the first temple 250 may be operatively connected to the first end piece 230 using a first hinge portion 255. The first hinge portion 255 may be rotatably configured such that the first temple 250 is folded or unfolded with respect to the first rim 210. For example, the first temple 250 may extend along the left side of the head of the user. When the user wears the electronic device 200, for example, a distal end part (e.g., the y-axis direction) of the first temple 250 may be configured in a bent shape to be supported by the left ear of the user. The second temple 260 may be operatively connected to the second end piece 240 using a second hinge portion 265. The second hinge portion 265 may be rotatably configured such that the second temple 260 is folded or unfolded with respect to the second rim 220. For example, the second temple 260 may extend along the right side of the head of the user. When the user wears the electronic device 200, for example, a distal end part (e.g., the y-axis direction) of the second temple 260 may be configured in a bent shape to be supported by the right ear of the user.

According to various embodiments, the first temple 250 may include a first printed circuit board 251, a first sound output module 253 (e.g., the sound output module 155 of FIG. 1), and/or a first battery 257 (e.g., the battery 189 of FIG. 1). The second temple 260 may include a second printed circuit board 261, a second sound output module 263 (e.g., the sound output module 155 of FIG. 1), and/or a second battery 267 (e.g., the battery 189 of FIG. 1).

According to various embodiments, various electronic components (e.g., at least some of the components included in the electronic device 101 of FIG. 1) such as the processor 120, the memory 130, the interface 177, and/or the wireless communication module 192 shown in FIG. 1 may be disposed in the first printed circuit board 251 and/or the second printed circuit board 261. The processor may include, for example, one or more of a central processing unit, an application processor, a graphic processing unit, an image signal processor, a sensor hub processor, or a communication processor. The description above of the processor 120 applies equally here. The first printed circuit board 251 and/or the second printed circuit board 261 may include, for example, a printed circuit board (PCB), a flexible PCB (FPCB), or a rigid-flexible PCB (RFPCB). In various embodiments, the first printed circuit board 251 and/or the second printed circuit board 261 may include a primary PCB, a secondary PCB disposed to partially overlap the primary PCB, and/or an interposer substrate between the primary PCB and the secondary PCB. The first printed circuit board 251 and/or the second printed circuit board 261 may be electrically connected to other components (e.g., the camera module 203, the first gaze tracking camera 205, the second gaze tracking camera 207, the audio module 209, the first microphone 211, the first recognition camera 213, the first light-emitting device 217, the first display module 219, the second microphone 221, the second recognition camera 223, the second light-emitting device 227, the second display module 229, the first sound output module 253, and/or the second sound output module 263) using an electrical path such as a FPCB and/or a cable. For example, the FPCB and/or the cable may be disposed in at least a part of the first rim 210, the bridge 201, and/or the second rim 220. In various embodiments, the electronic device 200 may include only one of the first printed circuit board 251 or the second printed circuit board 261.

According to various embodiments, the first sound output module 253 and/or the second sound output module 263 may transmit an audio signal to the left ear and/or the right ear of the user. The first sound output module 253 and/or the second sound output module 263 may include, for example, a piezo speaker (e.g., a bone conduction speaker) configured to transmit an audio signal without a speaker hole. In various embodiments, the electronic device 200 may include only one of the first sound output module 253 or the second sound output module 263.

According to various embodiments, the first battery 257 and/or the second battery 267 may supply power to the first printed circuit board 251 and/or the second printed circuit board 261 using a power management module (e.g., the power management module 188 of FIG. 1). The first battery 257 and/or the second battery 267 may include, for example, a non-rechargeable primary battery, a rechargeable secondary battery, or a fuel cell. In various embodiments, the electronic device 200 may include only one of the first battery 257 or the second battery 267.

According to various embodiments, the electronic device 200 may include a sensor module (e.g., the sensor module 176 of FIG. 1). The sensor module may generate an electrical signal or a data value corresponding to an internal operating state of the electronic device 200 or an external environment state. The sensor module may further include, for example, at least one of a gesture sensor, a gyro sensor, a barometric pressure sensor, a magnetic sensor, an acceleration sensor, a grip sensor, a color sensor, an infrared (IR) sensor, a biometric sensor (e.g., an HRM sensor), a temperature sensor, a humidity sensor, or an illumination sensor. In various embodiments, the sensor module may recognize biometric information of the user using various biometric sensors (or biometric sensors) such as an olfactory sensor (e-nose sensor), an electromyography sensor (EMG sensor), an electroencephalogram sensor (EEG sensor), an electrocardiogram sensor (ECG sensor), or an iris sensor.

FIG. 3 is a diagram illustrating an example optical system including a wave guide of an electronic device according to various embodiments.

According to various embodiments, an electronic device (e.g., the electronic device 101 of FIG. 1) may include an optical system 301 including a display 310 configured to output light including an augmented reality image and wave guides 320a, 320b, and 320c configured to transmit light output from the display 310 toward a user's eyes. The wave guides 320a, 320b, and 320c may be configured as a part of glass of the electronic device or may be attached to the glass. The electronic device may include a first glass member (e.g., the first glass member 215 of FIG. 2) disposed in front of the left eye of the user, and a second glass member (e.g., the second glass member 225 of FIG. 2) disposed in the right eye of the user, when the user wears the device, and the wave guides 320a, 320b, and 320c may be disposed in each of the first glass member and the second glass member. FIG. 3 illustrates a structure of the wave guides 320a, 320b, and 320c disposed in the first glass member according to an embodiment, and the wave guides 320a, 320b, and 320c disposed in the second glass member may be configured symmetrically in a left-right direction (e.g., the x-axis direction) as illustrated.

According to various embodiments, the display 310 (e.g., the first display module 219 of FIG. 2) may include an emissive or projector-type display which outputs light, and may be configured by a liquid crystal on silicon (LCoS), an organic light-emitting diode (OLED) (or uOLED), a light-emitting diode (LED) (or uLED), or an LED on silicon (LEDoS), without being limited thereto. The light output from the display 310 may be incident on the wave guides 320a, 320b, and 320c in a substantially vertical direction (e.g., the −y-axis direction). The display 310 may be disposed substantially parallel to the wave guides 320a, 320b, and 320c, but is not limited thereto, and may be inclined at a predetermined angle with respect to the wave guides 320a, 320b, and 320c. The display 310 may also be referred to as a display engine, a display light source, a display module, or a display projector.

According to an embodiment, a collimating lens 315 may be disposed between the display 310 and the wave guides 320a, 320b, and 320c. The collimating lens 315 may focus a beam emitted from the display 310 into the form of parallel light and cause the beam to be incident on the wave guides 320a, 320b, and 320c. The collimating lens 315 may be configured by at least one lens. The light output from a specific pixel 312 of the display 310 and diffused may be incident on the wave guides 320a, 320b, and 320c in the form of parallel light by the collimating lens 315. According to an embodiment, the display 310 may output parallel light in a vertical direction toward the wave guides 320a, 320b, and 320c, and in this case, the collimating lens 315 may be omitted.

According to various embodiments, the wave guides 320a, 320b, and 320c may transmit light output from the display 310 to the user's eyes using the total internal reflection principle. The wave guides 320a, 320b, and 320c may include a medium (e.g., glass, plastic, or a polymer material) capable of totally reflecting light of a visible band incident on a first surface or a second surface. Lateral surfaces of the wave guides 320a, 320b, and 320c may include a shielding structure to prevent and/or reduce light from being exposed to the lateral surfaces (e.g., in the −x/+x direction).

According to an embodiment, the electronic device may include the multiple wave guides 320a, 320b, and 320c configured to guide light of various wavelength bands toward the user's eyes. For example, the electronic device may include a first wave guide 320a capable of totally reflecting light of the red (R) band (e.g., 630 to 750 nm), a second wave guide 320b capable of totally reflecting light of the green (G) band (e.g., 495 to 570 nm), and a third wave guide 320c capable of totally reflecting light of the blue (B) band (e.g., 450 to 495 nm). For example, among the light output from the display 310, an R-band light component may be reflected by the first wave guide 320a, a G-band light component may pass through the first wave guide 320a to be reflected by the second wave guide 320b, and a B-band light component may pass through the first wave guide 320a and the second wave guide 320b to be reflected by the third wave guide 320c.

According to various embodiments, the electronic device may include in-couplers 332a, 332b, and 332c configured to change an optical path so that light incident on a wave guide substrate is totally reflected into the wave guides. Referring to FIG. 3, the electronic device may include a first in-coupler 332a configured to change an optical path of the R band into the first wave guide 320a, a second in-coupler 332b configured to change an optical path of the G band into the second wave guide 320b, and a third in-coupler 332c configured to change an optical path of the B band into the third wave guide 320c.

According to various embodiments, the in-couplers 332a, 332b, and 332c may be configured by transmissive or reflective diffractive elements. Referring to FIG. 3, the first in-coupler 332a is a reflective diffractive element disposed on a second surface (e.g., a surface in the −y direction of the first wave guide 320a) of the first wave guide 320a, and may reflect and diffract a part of light incident in the vertical direction (e.g., the −y direction) from the display 310 (or the collimating lens 315) to the right (e.g., the −x direction). According to an embodiment, the first in-coupler 332a may be configured by a transmissive diffractive element, and in this case, the first in-coupler 332a may be disposed on a first surface (e.g., a surface in the +y direction of the first wave guide 320a) of the first wave guide 320a to transmit and diffract a part of light incident in the vertical direction from the display 310 (or the collimating lens 315) to the right.

According to various embodiments, the electronic device may include out-couplers 334a, 334b, and 334c configured to change an optical path so that light reflected within the wave guides is transmitted toward the user's eyes. Referring to FIG. 3, the electronic device may include a first out-coupler 334a configured to guide an R-band light component transmitted through the first wave guide 320a toward the user's eyes (e.g., the y direction), a second out-coupler 334b configured to guide a G-band light component transmitted through the second wave guide 320b toward the user's eyes, and a third out-coupler 334c configured to guide a B-band light component transmitted through the third wave guide 320c toward the user's eyes.

According to various embodiments, the out-couplers 334a, 334b, and 334c may be configured by transmissive or reflective diffractive elements disposed in a direction of the user's gaze. Referring to FIG. 3, the first out-coupler 334a is a reflective diffractive element disposed on the second surface of the first wave guide 320a, and may reflect and diffract light reflected from the first surface after passing through the wave guides toward the user's eyes (e.g., the y direction). According to an embodiment, the first out-coupler 334a may be configured by a transmissive diffractive element, and in this case, the first out-coupler 334a may be disposed on the first surface of the first wave guide 320a and transmit and diffract light reflected from the second surface toward the user's eyes.

Although FIG. 3 illustrates an embodiment in which the electronic device includes multiple wave guides 320a, 320b, and 320c configured to guide light of R, G, and B bands, respectively, the disclosure is not limited thereto. For example, the electronic device may include one wave guide configured to guide light of the entire visible band output from the display 310 toward the user's eyes. In this case, only one in-coupler and one out-coupler may be included.

According to various embodiments, the electronic device may generate an augmented reality image (or content) in consideration of a current location of the user, a gaze direction, a surrounding object, etc. The electronic device may output the generated augmented reality image through the display 310, and light may be transmitted through the wave guides 320a, 320b, and 320c so that real-world information and the augmented reality image may be overlappingly displayed to the user's eyes. For example, when the user is looking at a specific building, the electronic device may track the user's gaze to identify the corresponding building, obtain information related to the corresponding building through a network, and output the information through the display 310. When the electronic device displays an augmented reality image, an optical path formed through the display 310—the in-couplers 332a, 332b, and 332c—the wave guides 320a, 320b, and 320c—the out-couplers 334a, 334b, and 334c—the user's eyes is designed to be constant, and thus a position of the augmented reality image recognized from the user's gaze may be determined according to a display position of the augmented reality image on the display 310. However, when the arrangement of each component is misaligned or a gap occurs during a manufacturing process or usage process of the electronic device, an error may occur in a predetermined optical path. For example, the flatness, surface roughness, bending, and/or misalignment of the wave guides may occur due to a manufacturing tolerance of a wave guide system of the electronic device. In addition, an optical path may deviate from the initial design due to thermal deformation (or expansion) of an optical mechanism caused by a physical impact or a high-temperature condition during use of the electronic device. Accordingly, an error in the optical system 301 may occur, such as an augmented reality image visible to the user's gaze appearing misaligned or distorted compared to a normal state.

Hereinafter, various example embodiments for detecting and compensating for a position error of an augmented reality image which may occur due to the above reasons will be described in greater detail.

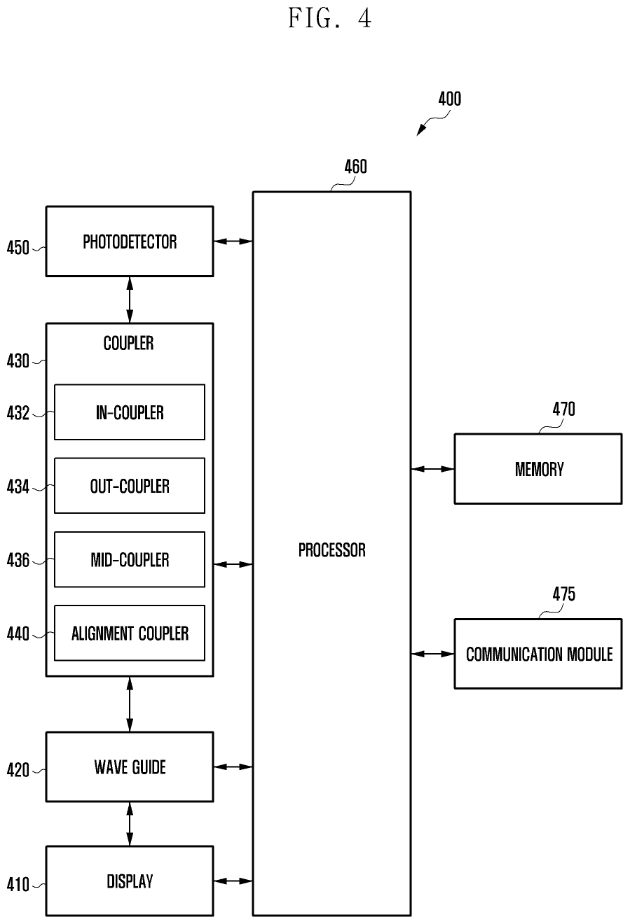

FIG. 4 is a block diagram illustrating an example configuration of an electronic device according to various embodiments.

Referring to FIG. 4, an electronic device 400 may include a processor (e.g., including processing circuitry) 460, a memory 475, a communication module (e.g., including communication circuitry) 475, a display 410, a wave guide 420, multiple couplers 430, and a photodetector 450, and even when a part of the illustrated configuration is omitted or substituted, various embodiments of the disclosure may be implemented. The electronic device 400 may be a wearable electronic device 400 (e.g., AR glasses or an HMD) which provides an augmented reality image, such as the electronic device 200 of FIG. 2, but the disclosure is not limited thereto. The electronic device 400 may further include at least a part of the configuration and/or functions of the electronic device 101 of FIG. 1.

According to various embodiments, the display 410 (e.g., the first display module 219 of FIG. 2 or the display 310 of FIG. 3) may output light including an augmented reality image. The display is an emissive or projector-type display which outputs light and may be configured by a liquid crystal on silicon (LCoS), an organic light-emitting diode (OLED) (or uOLED), a light-emitting diode (LED) (or uLED), or an LED on silicon (LEDoS), without being limited thereto.

According to various embodiments, the electronic device 400 may include a diffractive optical system for directing light output from the display 410 toward a user's eyes. In such the augmented reality display 410 based on the wave guide 420 using a diffractive optical system, the light incident on an in-coupler 432 may be diffracted at an angle which allows total internal reflection within the wave guide 420, and may travel within a substrate. The light which has traveled up to an out-coupler 434 disposed in front of the eyes may be diffracted by the out-coupler 434 at the same incident angle as when the light is incident, and may be extracted toward the eyes. As such, in the electronic device 400 based on a diffractive coupler, an angle of travel of coupled light may be determined by changing a period of a diffractive grating.

According to various embodiments, the electronic device 400 may include the wave guide 420 (e.g., the wave guides 320a, 320b, and 320c of FIG. 3) configured to transmit light output from the display 410 toward the user's eyes. As described above with reference to FIG. 3, the electronic device 400 may include multiple wave guides 420 (e.g., the first wave guide 320a, the second wave guide 320b, and the third wave guide 320c of FIG. 3) configured to guide light of each wavelength band (e.g., the red (R) band, green (G) band, and blue (B) band) toward the user's eyes. According to an embodiment, the electronic device 400 may include one wave guide 420 configured to guide light of the entire visible band output from the display 410 toward the user's eyes.

According to various embodiments, the electronic device 400 may include at least one coupler 430 for diffracting incident light so that the light travels toward the user's eyes. For example, the in-coupler 432 may change an optical path so that light output from the display 410 and incident on a substrate of the wave guide 420 is totally reflected into the wave guides 420. The out-coupler 434 may change an optical path so that light transmitted within the wave guide 420 is transmitted toward the user's eyes. A mid-coupler 436 may change a traveling direction of light to be in a substantially vertical direction (e.g., from the x-axis direction to the y-axis direction) when the wave guide 420 has a two-dimensional structure (e.g., an exit-pupil expanding (EPE) structure). The mid-coupler 436 may be omitted when the wave guide 420 has a one-dimensional structure (e.g., the wave guides 320a, 320b, and 320c of FIG. 3).

According to various embodiments, an alignment coupler 440 is disposed on an optical path formed by the wave guide 420 to diffract at least a part of incident light at a predetermined angle, thereby allowing at least a part of the light to be incident on the photodetector 450. The alignment coupler 440 is an optical coupler additionally inserted into an optical system (e.g., the optical system 301 of FIG. 3), and may serve to extract a part of a beam bundle directed from the in-coupler 432 to the out-coupler 434 to the outside of the wave guide 420. The alignment coupler 440 may be disposed after the in-coupler 432 and before the out-coupler 434 on the optical path within the wave guide 420.

According to various embodiments, each coupler may be configured by a transmissive diffractive element or a reflective diffractive element. A type (e.g., a transmissive diffractive element or a reflective diffractive element) and a position of each coupler are not limited, and may be designed in various manners so that light output from the display 410 travels toward the user's eyes.

According to an embodiment, when the electronic device 400 includes multiple wave guides (e.g., the first wave guide 320a, the second wave guide 320b, and the third wave guide 320c of FIG. 3), each coupler may also be disposed to correspond to each wave guide 420.

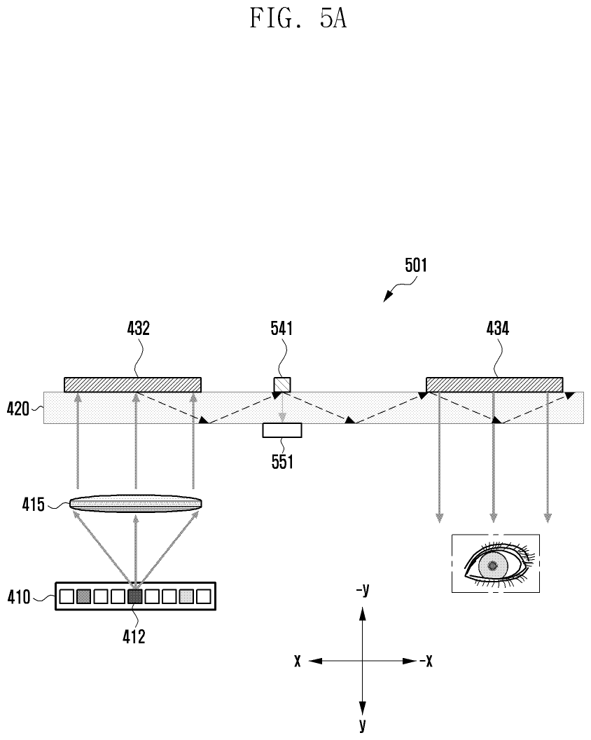

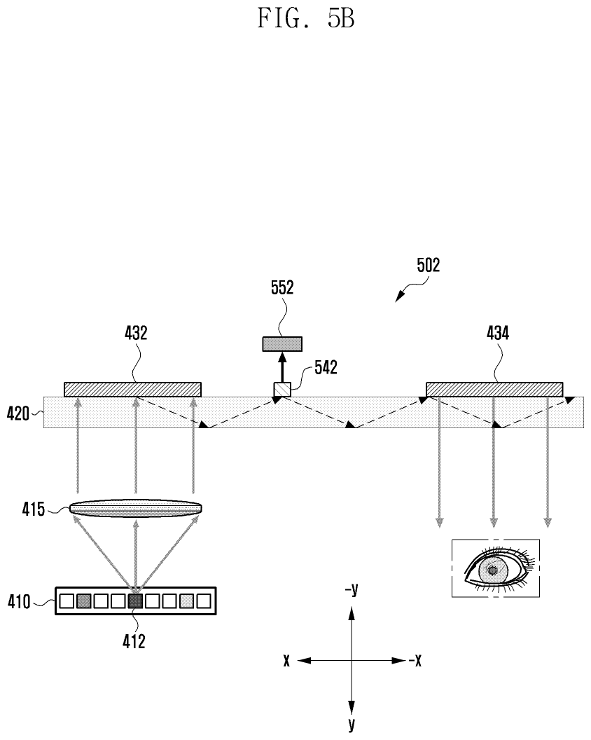

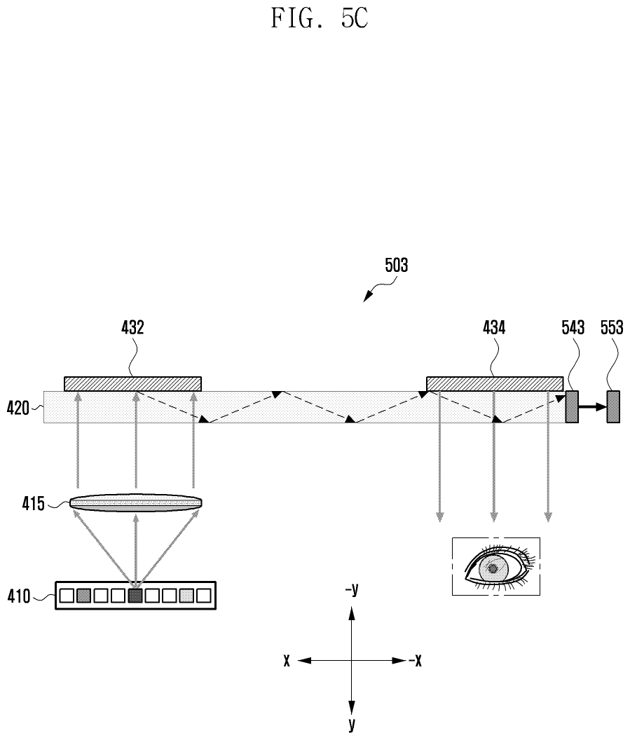

According to various embodiments, the photodetector 450 may include an optical sensor which detects light energy and outputs the same as an electrical signal. The photodetector 450 may detect light which is diffracted by the alignment coupler 440 and comes out of the substrate of the wave guide 420. The photodetector 450 may be positioned on an optical path of the light diffracted by the alignment coupler 440, and may be positioned in a vertical direction, but the disclosure is not limited thereto. According to an embodiment, when the alignment coupler 440 is configured by a reflective coupler, in the wave guide 420, the photodetector 450 may be disposed on an opposite surface to a surface where the alignment coupler 440 is positioned (e.g., FIG. 5A), and when the alignment coupler 440 is configured by a transmissive coupler, the photodetector 450 may be disposed on the opposite side of the wave guide 420 from the alignment coupler 440 (e.g., FIG. 5B). Alternatively, the photodetector 450 may be disposed on a lateral surface of the wave guide 420 (e.g., FIG. 5C). The alignment coupler 440 may be disposed to be spaced apart from a first surface or a second surface of the wave guide 420 by a predetermined gap. Embodiments related to arrangement positions of the alignment coupler 440 and the photodetector 450 will be described in greater detail below with reference to FIGS. 5A, 5B, and 5C.

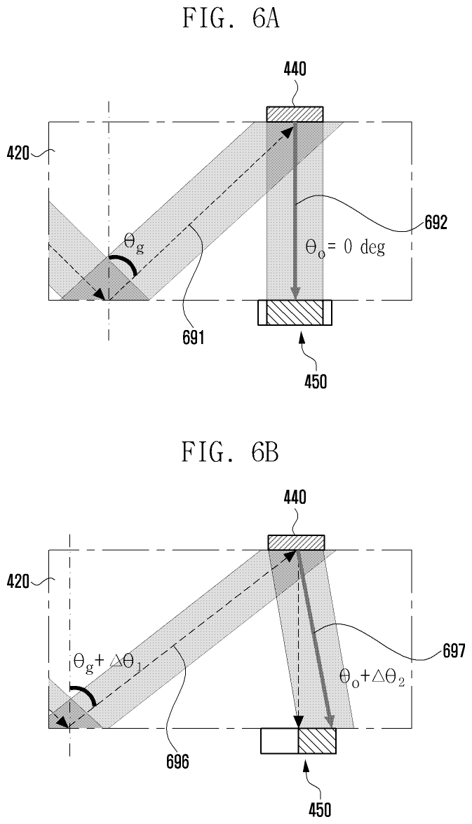

According to an embodiment, the photodetector 450 may be configured as a photo diode sensor which outputs an electrical signal corresponding to the amount of incident light. For example, the photo diode sensor may be designed to detect light greater than or equal to a specific value when initially designed, that is, when there is no position error in an optical path. When the optical path is changed due to an error in a manufacturing process of the optical system or a deformation that occurs during use, the amount of detected light may decrease a value equal to or less than the specific value, so that the size of the output electrical signal may be reduced. An embodiment in which the photodetector 450 is implemented as a photo diode sensor will be described in detail with reference to FIG. 6.

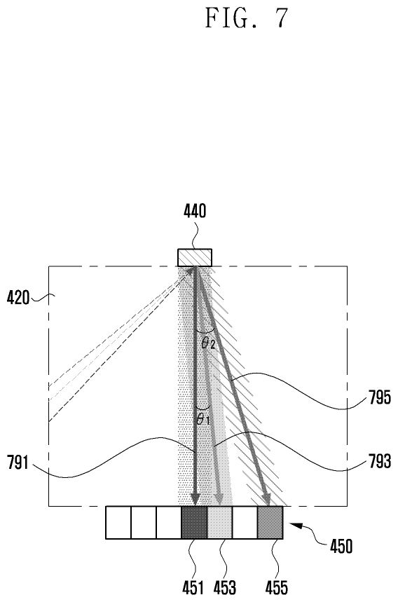

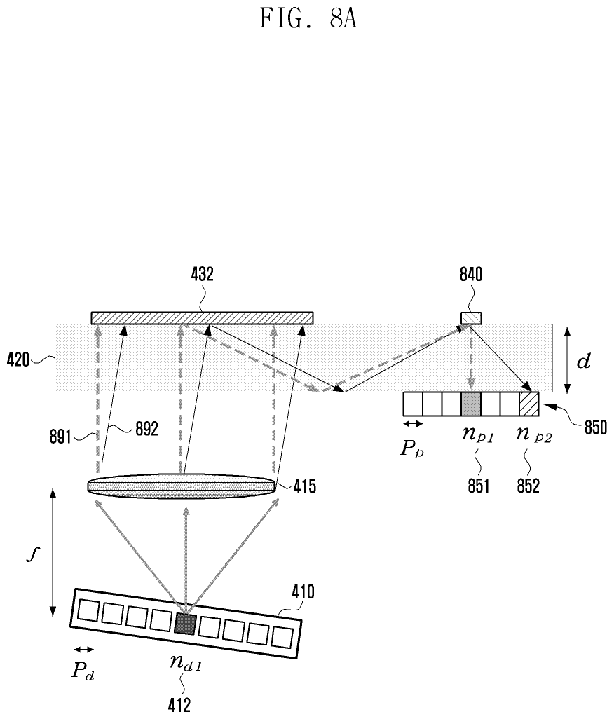

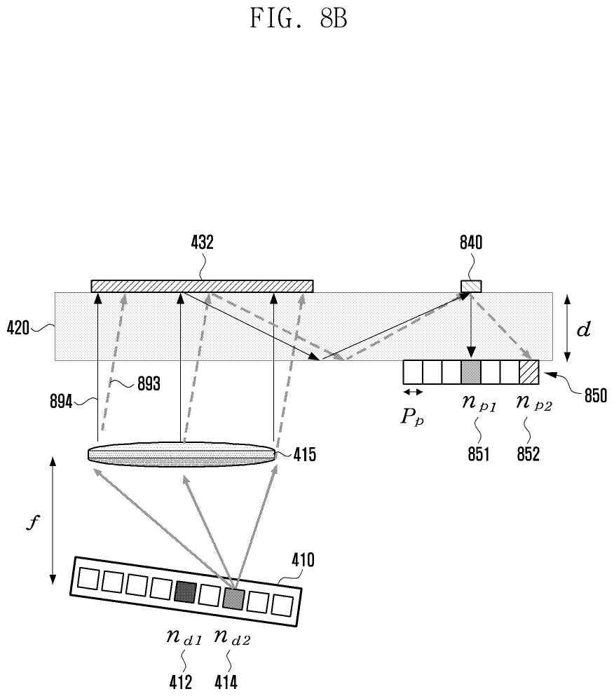

According to an embodiment, the photodetector 450 may be configured as an active sensor in the form of a pixel array. For example, the photodetector 450 may be implemented as a complementary metal-oxide semiconductor (CMOS) sensor or a charge-coupled device (CCD) sensor including multiple pixels (or sensor elements), but is not limited thereto. Each pixel of the photodetector 450 may be arranged in a direction perpendicular to a path of light incident from the alignment coupler 440, and a pixel which senses light may be changed depending on an incident angle of the incident light. An embodiment in which the photodetector 450 is implemented as an active sensor in the form of a pixel array will be described in detail with reference to FIGS. 7, 8A, and 8B.

According to various embodiments, the communication module 475 may include various hardware (e.g., various communication circuitry) and/or software configurations for communicating with an external device through a wireless communication network. The communication module 475 may include a cellular communication module which supports cellular wireless communication (e.g., 4G and 5G cellular communication) and a short-range wireless communication module which supports short-range wireless communication (e.g., Wi-Fi and Bluetooth). For example, the electronic device 400 may communicate with another electronic device (e.g., the electronic device 102 or the electronic device 104 of FIG. 1) and/or a server (e.g., the server 108 of FIG. 1) on a network using a cellular wireless communication module or a short-range wireless communication module.

According to various embodiments, the memory 470 may include a volatile memory and a non-volatile memory, and temporarily or permanently store various data. The memory 470 may include at least a part of the configuration and/or functions of the memory 130 of FIG. 1, and may store the program 140 of FIG. 1.

According to various embodiments, the memory 470 may store various instructions which may be executed by the processor 460. Such instructions may include control commands such as arithmetic and logical operations, data movement, and input/output which may be recognized by the processor 460.

According to various embodiments, the processor 460 may include various processing circuitry and be configured to perform an operation or data processing relating to control and/or communication of each component of the electronic device 400, and one or more processors 460 may be configured. The processor 460 may include at least a part of the configuration and/or functions of the processor 120 of FIG. 1 and the description provided above with respect to processor 120 is equally applicable here.

According to various embodiments, there is no limitation to operation and data processing functions that the processor 460 may implement on the electronic device 400, but the disclosure will describe in detail various embodiments in which the electronic device 400 detects a position error of an optical system including the display 410, the coupler 430, and the wave guide 420, based on an electrical signal received from the photodetector 450, and corrects a position path of an augmented reality image, based thereon. The operations of the processor 460 to be described later may be performed by loading instructions stored in the memory 470.

According to various embodiments, the processor 460 may generate an augmented reality image and output the augmented reality image through the display 410. For example, the processor 460 may track the user's gaze through a gaze tracking unit (not shown), identify a real object toward which the user's gaze is directed, and generate an augmented reality image related to the identified object. The processor 460 may obtain augmented reality information related to an external object from an external electronic device (e.g., the electronic device 102 or the electronic device 104 of FIG. 1) connected through short-range wireless communication or an external server connected through a network, and generate an augmented reality image. The processor 460 may generate an augmented reality image so that an external object and the augmented reality image may overlap or be adjacent to each other on an eyepiece. An optical path formed through the display 410—the in-coupler 432—the wave guide 420—the out-coupler 434—the user's eyes in the optical system of the electronic device 400 is designed to be constant, and thus a position of an augmented reality image recognized from the user's gaze may be determined according to a display position of the augmented reality image on the display 410.

According to various embodiments, the processor 460 may determine a position error of an augmented reality image incident on the user's eyes. When the optical system of the electronic device 400 is initially designed, a light output position of the display 410 and a position of an augmented reality image formed on an eyepiece may be designed to match, but when the arrangement of each component is misaligned or a gap occurs during a manufacturing process or usage process of the electronic device 400, an error may occur in a predetermined optical path. When a position error monitoring mode is initiated, the processor 460 may activate and output only some pixels of the display 410 to detect a position error. The position error monitoring mode may be activated by the user through a separate option, or may be activated according to a specific cycle for a short time that is unnoticeable to the user during a process of displaying a general augmented reality image.

According to various embodiments, the processor 460 may determine a position error of an augmented reality image, based on information related to an electrical signal received from the photodetector 450 or light detected by the photodetector.

According to an embodiment, the photodetector 450 may be configured as a photo diode sensor which outputs an electrical signal corresponding to the amount of incident light. For example, the light output from the display 410 may be incident into the wave guide 420, diffracted through the in-coupler 432, and thus travel within the wave guide 420, and at least a part of the light may travel in a direction of the photodetector 450 by the alignment coupler 440 along the optical path. In this embodiment, the light diffracted by the alignment coupler 440 may be designed such that the entire light (or a predetermined ratio or more) is detected by the photodetector 450, and when an error occurs in the optical system, at least a part of the light diffracted by the alignment coupler 440 may travel in a direction other than the photodetector 450. The photodetector 450 may transmit an electrical signal (e.g., a current) corresponding to the amount of detected light to the processor 460, and the processor 460 may identify whether a position error of an augmented reality image has occurred or the degree of the error depending on the size of the received electrical signal. This embodiment will be described in detail with reference to FIG. 6.

According to an embodiment, the photodetector 450 may be configured as an active sensor in the form of a pixel array including multiple pixels. In this embodiment, when the optical system is in a normal state, the light diffracted by the alignment coupler 440 may be designed to be detected by a predetermined pixel (or pixels) among the pixel array, and when a position error occurs in the optical system, the light diffracted by the alignment coupler 440 may be detected by a pixel (or pixels) other than the predetermined pixel. The photodetector 450 may transmit information about the pixel which has detected the light to the processor 460, and the processor 460 may identify whether a position error of an augmented reality image has occurred or the degree of the error, based on a position of the corresponding pixel. This embodiment will be described in detail with reference to FIGS. 7, 8A, and 8B.

According to various embodiments, the processor 460 may compensate for a position of light incident on the wave guide 420 from the display 410 in order to compensate for a position error of an augmented reality image. For example, when it is identified that, due to an error in the optical system, the augmented reality image is displayed in a state of being displaced by “a” in the x-axis direction compared to a normal state, the processor 460 may compensate for the displacement of the augmented reality image to make the image be displayed while being shifted by “-a” on the eyepiece if the image were in the normal state, so that the augmented reality image is displayed at a normal position on the eyepiece despite the position error.

According to an embodiment, the processor 460 may be configured to output, through the display 410, a compensated augmented reality image which is obtained by shifting pixel data of the augmented reality image, based on the position error of the augmented reality image. For example, when it is identified that the augmented reality image is shifted by k pixels and displayed compared to the normal state, the processor 460 may correct pixel data of n to m pixels of the augmented reality image to pixel data of (n-k) to (m-k) pixels, thereby shifting the pixel data of the augmented reality image by k pixels.

According to an embodiment, the electronic device 400 may adjust an incident angle of light output from the display 410 using an additional mechanical variable system (e.g., a translation motor stage and an MEMS mirror). According to an embodiment, the electronic device 400 may include a conversion motor (not shown) configured to adjust an angle between the display 410 and the wave guide 420, and the processor 460 may adjust an angle at which light output from the display 410 is incident on the wave guide 420 by adjusting an angle of the display 410 by the conversion motor, based on a position error of the augmented reality image.

According to various embodiments, the processor 460 may compensate for a position of light incident on the wave guide 420 from the display 410, and display a compensated augmented reality image, and then undergo an identification process of a user. For example, the processor 460 may display the compensated augmented reality image and then display a menu which allows the user to select whether the augmented reality image is displayed in a correct position, and when an input is given that the augmented reality image has been displayed in the correct position based on a user input (e.g., a button input or a voice input), the compensated augmented reality image may be continuously displayed. Alternatively, when the user inputs that the compensated augmented reality image is not displayed in the correct position, the processor may restore to before the compensation and perform the compensation operation again, or display a user notification including information indicating that repair of the optical system is required.

According to various embodiments, the processor 460 may compensate for a position of light incident on the wave guide 420 from the display 410 according to the degree of a position error of an augmented reality image, or output a notification indicating the position error. For example, when the position error of the augmented reality image is less than a first reference value, the processor 460 may output the augmented reality image as it is without performing separate compensation since the image is close to a normal state. When the position error of the augmented reality image is greater than or equal to the first reference value, the processor 460 may compensate for a position of light incident on the wave guide 420 from the display 410 by the above-described embodiment. When the position error of the augmented reality image is greater than or equal to a second reference value, which is higher than the first reference value, since it is difficult to display the augmented reality image in the correct position by the above-described compensation method, the processor 460 may display, through the display 410, a user notification including information indicating that repair of the optical system is required without performing compensation.

FIGS. 5A, 5B, and 5C are diagrams illustrating example arrangement structures of a wave guide, an alignment coupler, and a photodetector of an electronic device according to various embodiments.

FIGS. 5A, 5B, and 5C may illustrate structures of an example wave guide and a coupler corresponding thereto (e.g., the first in-coupler 332a and the first out-coupler 334a of FIG. 3) and a photodetector in an optical system including multiple wave guides (e.g., the first wave guide 320a, the second wave guide 320b, or the third wave guide 320c of FIG. 3) included in an electronic device. According to an embodiment, when the electronic device includes one wave guide, the electronic device may include a structure of the wave guide and a coupler corresponding thereto and the photodetector. Hereinafter, in the wave guide of FIGS. 5A, 5B, and 5C, a surface in the y direction close to the display may be referred to as a first surface, and a surface in the −y direction opposite to the first surface may be referred to as a second surface.

According to an embodiment, an alignment coupler 541 may be disposed on a second surface of the wave guide 420, and the alignment coupler may be configured by a reflective diffractive element which diffracts light in a direction opposite to a direction of incidence. According to an embodiment, a photodetector 551 may be disposed on a first surface of the wave guide 420 to detect light incident from the alignment coupler.

Referring to an optical system 501 of FIG. 5A, the light output from the display 410 may be diffracted by a collimating lens 415 to be incident on the wave guide 420 in the form of parallel light. When an error monitoring mode is initiated, a processor (e.g., the processor 460 of FIG. 4) may activate a predetermined specific pixel (or multiple pixels) 412 among multiple pixels of the display 410 to output light.

The light output from the display 410 and incident into the wave guide 420 may be diffracted in the −x direction by the in-coupler 432 and travel, and may be reflected by the first surface of the wave guide 420. At least a part of the light reflected from the first surface may be incident on the alignment coupler 541 and may be reflected and diffracted in a direction of the photodetector 551 by the alignment coupler 541. The photodetector 551 may be positioned vertically in the y-axis direction from the alignment coupler 541, and the alignment coupler 541 may reflect and diffract at least a part of the light traveling within the wave guide 420 in the y-direction. A part of the light traveling within the wave guide 420 that is not diffracted by the alignment coupler 541 may be reflected by the second surface and the first surface of the wave guide 420 and travel in the −x direction, and travel toward a user's eyes by the out-coupler 434. In FIG. 3A, the photodetector 551 is illustrated as being attached to the first surface of the wave guide 420, but according to an embodiment, the photodetector may be disposed to be spaced apart from the first surface of the wave guide 420 by a predetermined gap.

According to an embodiment, an alignment coupler 542 may include a transmissive diffractive grating disposed on the second surface of the wave guide 420, and a photodetector 552 may be positioned on the opposite side of the wave guide 420 from the alignment coupler 542.

Referring to an optical system 502 of FIG. 5B, the alignment coupler 542 may be disposed on an optical path on the second surface of the wave guide 420, and the photodetector 552 may be disposed in the −y direction from the alignment coupler 542. The light which is output from the display 410, incident into the wave guide 420, and diffracted by the in-coupler 432 may be transmitted and diffracted by the alignment coupler 542 to travel in the −y direction, and may be incident on the photodetector 552. A part of the light traveling within the wave guide 420 that is not diffracted by the alignment coupler 542 may be reflected by the second surface and the first surface of the wave guide 420 and travel in the −x direction, and travel toward a user's eyes by the out-coupler 434.

According to an embodiment, an alignment coupler 543 may be configured by a transmissive diffractive element disposed on a lateral surface of the wave guide 420, and the photodetector may be positioned on the opposite side of the wave guide 420 from the alignment coupler 543.

Referring to an optical system 503 of FIG. 5C, the alignment coupler 543 may be disposed on a lateral surface in the −x direction of the wave guide 420, and a photodetector 553 may be disposed to be further spaced apart from the alignment coupler 543 in the −x direction. The light which is output from the display 410, incident into the wave guide 420, and diffracted by the in-coupler 432 may travel toward eyes through the out-coupler 434. Here, a part of the light may be totally reflected at the same angle by the out-coupler 434 and incident on the alignment coupler 543, and may be transmitted and diffracted in a vertical direction by the alignment coupler 543 and incident on the photodetector 553. According to an embodiment, at least a part of a lateral surface of the wave guide 420 may be shielded so that light does not pass through, and the alignment coupler 543 and/or the photodetector 553 may be disposed in an unshielded area on the lateral surface of the wave guide 420.

FIGS. 6A and 6B are diagrams illustrating light detected by a photodetector according to various embodiments.

According to an embodiment, the photodetector 450 may be configured as a photo diode sensor which outputs an electrical signal corresponding to the amount of incident light. The photodetector 450 has a predetermined area and may output, to a processor, an electrical signal (e.g., a current) corresponding to an area on which light is incident.

FIG. 6A illustrates light incident on the photodetector 450 when an optical system including a display (e.g., the display 410 of FIG. 4 and FIG. 5A), the wave guide 420, and at least one coupler is in a normal state, and FIG. 6B illustrates light incident on the photodetector 450 in a state where an error occurs in a part of the optical system and a position error of an augmented reality image occurs.

According to an embodiment, the alignment coupler 440 and the photodetector 450 may be arranged in a vertical direction with respect to the wave guide 420. Accordingly, the light output from a specific pixel of the display may be diffracted by the alignment coupler 440 and incident on the photodetector 450 in a vertical direction (e.g., the y direction). Referring to FIG. 6A, the light traveling within the wave guide 420 may be reflected at an angle of θ_{g} from a first surface of the wave guide 420 (691), and diffracted by the alignment coupler 440 to be incident on the photodetector 450 at an angle of θ₀ (0°). In this case, the entirety of light 692 diffracted by the alignment coupler 440 to be incident may be incident on the photodetector 450, and the size of an electrical signal output from the photodetector 450 may have a large value.

According to various embodiments, an error may occur in a predetermined optical path due to a manufacturing tolerance of the wave guide 420 in a process of an electronic device or a physical change (e.g., mechanical shock or thermal deformation) that occur during use. Referring to FIG. 6B, the light traveling within the wave guide 420 due to the error occurring in the optical path may be reflected at an angle of θ_{g}+Δθ₁ greater than θ_{g} in a normal state on the first surface of the wave guide 420 (696). The alignment coupler 440 may be designed to reflect and diffract incident light at a predetermined angle, and accordingly, an angle of light 697 diffracted by the alignment coupler 440 may be θ₀+Δθ₂ greater than θ₀ in the normal state. In this case, since the angle of the light 697 incident on the photodetector 450 is θ₂°, not 0° in the normal state, only a part of the light may be detected by the photodetector 450, and the magnitude of an electrical signal output from the photodetector 450 may indicate a smaller value than a value in the normal state of FIG. 6A.

According to various embodiments, the photodetector 450 may output an electrical signal corresponding to the size (or area) of the incident light 692 and 697 to the processor, and the processor may detect an error in the optical system and a resulting position error of an augmented reality image, based on the electrical signal.

In this embodiment, since the processor determines an error in the optical system, based on an electrical signal (e.g., a current) incident from the photodetector 450, when the light diffracted and incident from the alignment coupler 440 is incident at the same angle to the right (−x direction) or the left (x direction), the light is detected in the same area of the photodetector 450, and thus, the size of the electrical signal output to the processor may also be the same. For example, in the cases where an incident angle of light is θ₀+Δθ₂ and is θ₀−Δθ₂ as in FIG. 6B, the magnitude of the electrical signal output to the processor may be the same. According to an embodiment, when the processor compensates for a position error of the augmented reality image, based on the input electrical signal, the processor may align the augmented reality image in one direction and output the augmented reality image to a user, and according to an identification result of the user, may align the augmented reality image in the opposite direction and provide the augmented reality image.

FIG. 7 is a diagram illustrating an example photodetector of an electronic device according to various embodiments.

According to an embodiment, the photodetector 450 may be configured as an active sensor in the form of a pixel array. For example, the photodetector 450 may be implemented as a complementary metal-oxide semiconductor (CMOS) sensor or a charge-coupled device (CCD) sensor including multiple pixels (or sensor elements), but is not limited thereto. Each pixel of the photodetector 450 may be arranged in a direction perpendicular to a path of light incident from the alignment coupler 440, and a pixel which senses light may be changed depending on an incident angle of the incident light.

Referring to FIG. 7, the alignment coupler 440 and the photodetector 450 may be arranged in a vertical direction with respect to the wave guide 420. Accordingly, the light output from a specific pixel of a display may be diffracted by the alignment coupler 440 to be incident on the photodetector 450 in a vertical direction (e.g., the y direction) (791), and in a normal state, light may be input to a first pixel 451 among multiple pixels of the photodetector 450. When an error occurs in an optical system during a manufacturing process or use, an angle of incidence of light 793 and 795 diffracted by the alignment coupler 440 to the photodetector 450 may be changed.

Referring to FIG. 7, the light 793 incident at an angle of θ₁ may be detected by a second pixel 453, and the light 795 incident at a larger angle of θ₂ may be detected by a third pixel 455 positioned farther from the first pixel 451 than the second pixel 453. The photodetector 450 may output an electrical signal including information of a pixel which has detected light to a processor, and the processor may determine the occurrence and/or degree of a position error of an augmented reality image, based on the identified pixel position.

In FIG. 7, the light diffracted by the alignment coupler 440 is shown as being detected by one pixel, but this is just one example, and the light may be designed to be detected by multiple pixels.

According to an embodiment, an electronic device may compare the degree of a position error of an augmented reality image with a reference value, and compensate for a position of light incident on the wave guide from the display, or output a notification indicating the position error. According to an embodiment, the electronic device may designate a specific pixel as a reference pixel with reference to a distance from the first pixel 451 designed to detect light in a normal state among multiple pixels included in the photodetector 450. For example, when the photodetector 450 includes 20 pixels, the third pixel on the left and/or right side with reference to the first pixel 451 in the middle may be designated as a first reference pixel, and the sixth pixel on the left and/or right side may be designated as a second reference pixel. When the light output from the display is detected at the first or second pixel on the left and/or right side with reference to the first pixel 451 of the photodetector, the electronic device may determine that the position error is less than a first reference value since the light has been detected at a pixel closer to the first pixel 451 than the first reference pixel, and may not perform separate compensation. When the light output from the display is detected at the third to fifth pixels on the left and/or right side with reference to the first pixel 451 of the photodetector, the electronic device may determine that the position error is greater than or equal to the first reference value and less than a second reference value since the light has been detected at a pixel closer than the second reference pixel, and perform a position compensation of the augmented reality image. When the light output from the display is detected at a pixel positioned sixth or beyond on the left and/or right side with reference to the first pixel 451 of the photodetector, the electronic device may determine that the position error is greater than or equal to the second reference value since the light has been detected at a pixel located farther than the second reference pixel, and provide a user notification including information that repair of the optical system is required without performing compensation.

FIGS. 8A and 8B are diagrams illustrating example optical paths before and after compensation of a position of light incident from a display in an electronic device according to various embodiments.

According to various embodiments, when an optical system of an electronic device is initially designed, a light output position of the display 410 and a position of an augmented reality image formed on an eyepiece may be designed to match, but when the arrangement of each component is misaligned or a gap occurs during a manufacturing process or usage process of the electronic device, an error may occur in a predetermined optical path.

FIG. 8A illustrates an optical path toward a photodetector 850 when an angle of the display 410 is tilted compared to the initial design. In FIG. 8A, a dotted line 891 may be an optical path in a case where no error occurs in the optical system, and a solid line 892 may be an optical path in a case where an error in the optical system occurs.

In the initial design, the display 410 may be disposed parallel to the collimating lens 415 and the wave guide 420 to output light in a vertical direction, and in an error monitoring mode, the display 410 may output light using at least one pixel among multiple pixels of the display 410. Referring to FIG. 8A, the electronic device may output light from pixel n_{d1} 412 located in the middle of the display 410 in the error monitoring mode, but is not limited thereto, and may output light from a pixel other than the middle, and may also output light from the multiple pixels that are adjacent to each other or at least partially non-adjacent. The light incident into the wave guide 420 may be diffracted by the in-coupler 432, totally reflected by a first surface of the wave guide 420, and reflected and diffracted by an alignment coupler 840 to form an optical path incident on pixel nₚ₁ 851 of the photodetector 850.

As shown in FIG. 8A, when an angle of the display 410 is tilted compared to the initial design, an optical path of the light output from the pixel n_{d1} 412 of the display 410 may be changed, and accordingly, the light diffracted by the alignment coupler 840 may be incident on pixel nₚ₂ 852 of the photodetector 850 or multiple pixels including the pixel nₚ₂. The photodetector 850 may output, to a processor, an electrical signal corresponding to the pixel nₚ₂ 852 of the photodetector 850 on which light is incident, and the processor may identify a position error of an augmented reality image from the received electrical signal.

According to an embodiment, the processor may be configured to output, through the display 410, a compensated augmented reality image which is obtained by shifting pixel data of the augmented reality image. For example, the processor may calculate a value And required for the image shift of the display 410 according to the following equation 1.

$$Δ {n}_{d} = \vert {n}_{d 1} - {n}_{d 2} \vert = \frac{f \cdot ( \frac{{p}_{p} \cdot \vert {n}_{d 1} - {n}_{d 2} \vert}{d} )}{{p}_{d}} \qquad [ Equation 1 ]$$

In the equation 1, d may represent a thickness of the wave guide 420, f may represent a focal length of the collimating lens 415, pp may represent a pixel pitch of the photodetector 850, pa may represent a pixel pitch of the display 410, nₚ₁ and nₚ₂ may represent pixel numbers of the photodetector 850, and n_{d1} and n_{d2} may represent pixel numbers of the display 410.

When Δn_{d} is calculated through the equation 1, the processor may generate an image shifted by the corresponding number of pixels, and output the image through the display 410.

FIG. 8B illustrates an optical path formed when an image shifted by a specified number of pixels (e.g., 2 pixels) is output by image alignment of the processor. In FIG. 8B, a dotted line 893 may be an optical path in a case where image alignment of a display is not performed when an error in the optical system occurs, and a solid line 894 may be an optical path in a case where image alignment of the display is performed.

Referring to FIG. 8B, when And is calculated as 2 according to a calculation result of equation 1 above, the display 410 may output light using n_{d2} 414, which is shifted by 2 pixels, instead of the initially determined pixel n_{d1} 412. The light incident into the wave guide 420 may be diffracted by the in-coupler 432, totally reflected by the first surface of the wave guide 420, and reflected and diffracted by the alignment coupler 840 to form an optical path incident on pixel nₚ₁ of the photodetector 850.

The processor may determine that a position error is compensated for by the shift when the light output from the pixel n_{d2} 414 of the display 410 is incident on the pixel nₚ₁ 851 of the photodetector 850, and may configure an augmented reality image shifted by 2 pixels and provide the augmented reality image to a user. Accordingly, the augmented reality image formed on an eyepiece of the user may be displayed exactly at the initially designed position.

According to an embodiment, the electronic device may include a conversion motor (not shown) configured to adjust an angle between the display 410 and the wave guide 420 or move a position, and the processor may adjust an angle at which light output from the display 410 is incident on the wave guide 420 by adjusting an angle of the display 410 by the conversion motor, based on a position error of the augmented reality image.

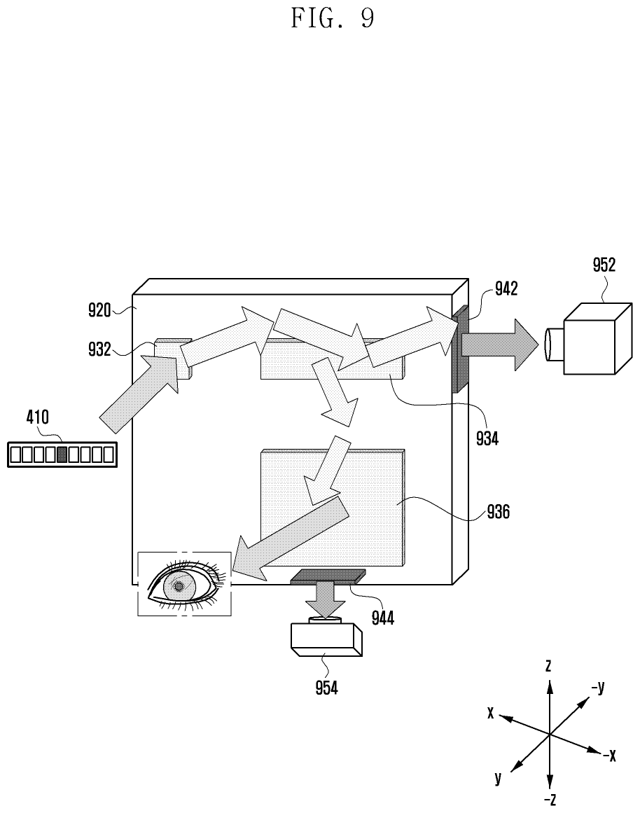

FIG. 9 is a diagram illustrating an example two-dimensional exit-pupil expanding (EPE) structure of an electronic device according to various embodiments.

According to an embodiment, a wave guide may include a two-dimensional exit-pupil expanding (EPE) structure which expands an eye box in both vertical and horizontal directions.

Referring to FIG. 9, a wave guide 920 may include a two-dimensional structure, and the display 410 may be disposed on a front surface in the y direction of the wave guide 920 to output light corresponding to an augmented reality image. The light output in the −y direction from the display 410 may be diffracted by an in-coupler 932 and travel in the −x direction, and at least a part of the light may be diffracted in the −z direction by a mid-coupler 934 and incident on an out-coupler 936. The out-coupler 936 may diffract at least a part of the incident light in the y direction so that the light may be recognized by a user's eyes.

According to an embodiment, the electronic device may include a first alignment coupler 942 disposed in a traveling direction of light that is not diffracted by the mid-coupler 934 and a first photodetector 952 configured to detect light diffracted by the first alignment coupler 942. Referring to FIG. 9, a part of light incident on the mid-coupler 934 may be reflected without being diffracted by the mid-coupler 934 and travel in the −x direction. The first alignment coupler 942 may be configured by a transmissive diffractive element disposed on a lateral surface in the −x direction of the wave guide 920, and may transmit and diffract light reflected by the mid-coupler 934 and traveling in the −x direction, so that the light may be incident on the first photodetector 952.

According to an embodiment, the electronic device may include a second alignment coupler 944 disposed in a traveling direction of light that is not diffracted by the out-coupler 936, and a second photodetector 954 configured to detect light diffracted by the second alignment coupler 944. Referring to FIG. 9, a part of light incident on the out-coupler 936 may be reflected without being diffracted by the out-coupler 936 and travel in the −z direction. The second alignment coupler 944 may be configured by a transmissive diffractive element disposed on a lateral surface in the −z direction of the wave guide 920, and may transmit and diffract light reflected by the out-coupler 936 and travelling in the −z direction, so that the light may be incident on the second photodetector 954.

The first photodetector 952 and the second photodetector 954 may be configured as a photo diode sensor (e.g., the photodetector 450 of FIG. 6) or an active sensor (e.g., the photodetector 450 of FIG. 7) in the form of a pixel array.

According to various embodiments, the electronic device may include at least one of the first alignment coupler 942 and the first photodetector 952, or the second alignment coupler 944 and the second photodetector 954, and may identify a position error of an augmented reality image and compensate for the position error, based on an electrical signal transmitted from the first photodetector 952 and/or the second photodetector 954.

An electronic device according to various example embodiments of the disclosure may include: a display configured to output light of an augmented reality image, a wave guide configured to transmit light output from the display toward a user's eyes, at least one alignment coupler disposed on an optical path formed by the wave guide, and configured to diffract at least a part of incident light at a specified angle, a photodetector configured to detect at least a part of light diffracted by the alignment coupler, and at least one processor, comprising processing circuitry, operatively connected to the display and the photodetector.

According to various example embodiments, at least one processor, individually and/or collectively, may be configured to identify information related to light detected by the photodetector.

According to various example embodiments, at least one processor, individually and/or collectively, may be configured to determine a position error of an augmented reality image incident on the user's eyes, based on the identified information.

According to various example embodiments, at least one processor, individually and/or collectively, may be configured to compensate for a position of light incident on the wave guide from the display to compensate for the determined position error.

According to various example embodiments, the electronic device may further include an in-coupler configured to diffract at least a part of light output from the display into the wave guide, and an out-coupler configured to diffract at least a part of light transmitted within the wave guide toward the user's eyes.

According to various example embodiments, the alignment coupler may be disposed on an optical path formed by the in-coupler and the out-coupler.

According to various example embodiments, the wave guide may include a first surface within a specified distance to the display and a second surface opposite the first surface, the alignment coupler may include a reflective diffractive grating disposed on the first surface of the wave guide, and according to various example embodiments, the photodetector may be disposed on the second surface of the wave guide.

According to various example embodiments, the wave guide may include a first surface within a specified distance to the display and a second surface opposite the first surface, the alignment coupler may include a transmissive diffractive grating disposed on the first surface of the wave guide, and the photodetector may be disposed on the opposite side of the wave guide from the alignment coupler.

According to various example embodiments, the photodetector may be disposed to be spaced apart from the wave guide by a specified gap.

According to various example embodiments, based on there being no position error, the photodetector may be disposed in a direction in which light diffracted by the alignment coupler is incident substantially vertically.

According to various example embodiments, the electronic device may further include an in-coupler configured to diffract at least a part of light output from the display into the wave guide, an out-coupler configured to diffract at least a part of light transmitted within the wave guide toward the user's eyes, and a mid-coupler configured to diffract at least a part of light diffracted by the in-coupler toward the out-coupler.

According to various example embodiments, the at least one alignment coupler may include at least one of a first alignment coupler disposed in a traveling direction of light that is not diffracted by the mid-coupler, or a second alignment coupler disposed in a traveling direction of light that is not diffracted by the out-coupler.

According to various example embodiments, at least one processor, individually and/or collectively, may be configured to check a current value corresponding to the amount of light detected by the photodetector and determine a position error of the augmented reality image, based on the identified current value.

According to various example embodiments, the photodetector may include multiple pixels.

According to various example embodiments, at least one processor, individually and/or collectively, may be configured to: identify at least one pixel among the multiple pixels that detects light diffracted by the alignment coupler, and determine a position error of the augmented reality image, based on the identified at least one pixel.

According to an example embodiment, at least one processor, individually and/or collectively, may be configured to output, through the display, a compensated augmented reality image obtained by shifting pixel data of the augmented reality image, based on the determined position error.

According to various example embodiments, the electronic device may further include a conversion motor configured to adjust an angle between the display and the wave guide.

According to various example embodiments, at least one processor, individually and/or collectively, may be configured to control the conversion motor to, based on the determined position error, adjust an angle of the display and adjust an angle at which light output from the display is incident on the wave guide.

According to various example embodiments, at least one processor, individually and/or collectively, may be configured to, based on the determined position error being greater than or equal to a first reference value, compensate for a position of light incident on the wave guide from the display, and based on the determined position error being greater than or equal to a second reference value greater than the first reference value, output a notification indicating the position error.

According to various example embodiments, at least one processor, individually and/or collectively, may be configured to, based on a user input which is input after compensating for the position of the light incident on the wave guide from the display, output the augmented reality image according to a result of the compensation, or restore to before the compensation.

According to various example embodiments, the electronic device may comprise augmented-reality (AR) glasses configured to display the augmented reality image by overlapping the augmented reality image with real-world information.

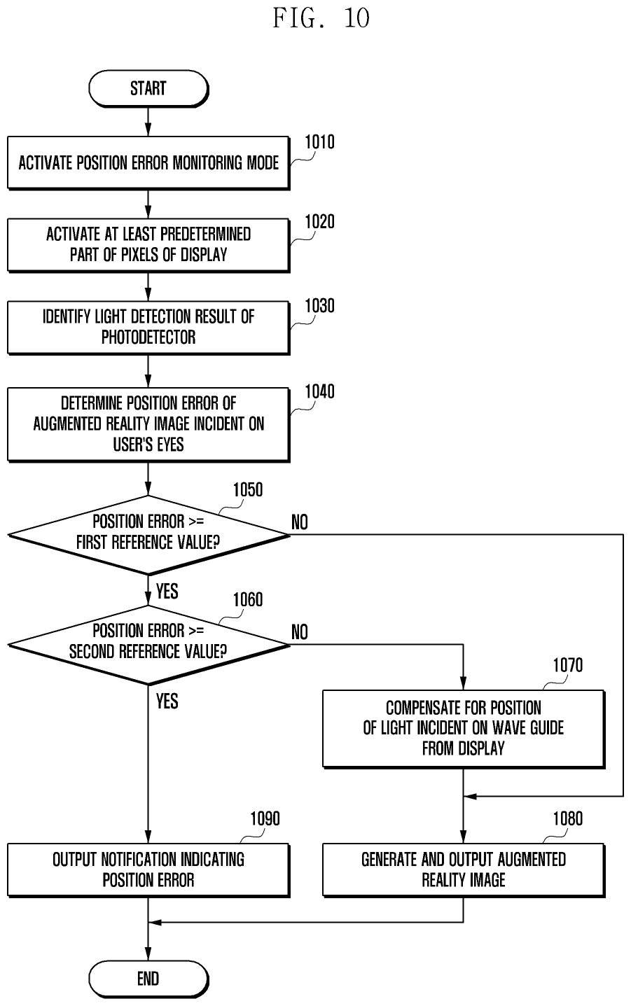

FIG. 10 is a flowchart illustrating an example augmented reality image compensation method of an electronic device according to various embodiments.

The illustrated method may be performed by an electronic device (e.g., the electronic device 400 of FIG. 4) described with reference to FIGS. 1 to 9, and the description of the technical features described above may not be repeated here.

According to various embodiments, in operation 1010, the electronic device may initiate or activate a position error monitoring mode for an augmented reality image. According to an embodiment, the position error monitoring mode may be activated by a user through a separate option, or may be activated according to a specific cycle for a short time that is unnoticeable to the user during a process of displaying a general augmented reality image.

According to various embodiments, in operation 1020, when the error monitoring mode is initiated, the electronic device may activate at least a predetermined part (e.g., a pixel of FIG. 5A) of display pixels. The light output from a predetermined pixel (or multiple pixels) of a display may be diffracted by a collimating lens and incident on a wave guide in the form of parallel light, and may be diffracted by an in-coupler and travel into the wave guide. The light reflected from one surface of the wave guide may be incident on an alignment coupler, diffracted by the alignment coupler, and incident on a photodetector. An arrangement structure of the alignment coupler and the photodetector and a path of travel of light output from the display have been described with reference to FIGS. 5A, 5B, and 5C.

According to various embodiments, in operation 1030, the electronic device may identify a light detection result of the photodetector. According to an embodiment, the photodetector may be configured as a photo diode sensor which outputs an electrical signal corresponding to the amount of incident light. In this case, at least one of whether the photodetector detects light, a detection location, or a detection area may be sensed, and a sensing result may be provided to a processor. This embodiment has been described with reference to FIG. 6.

According to an embodiment, the photodetector may be configured as an active sensor in the form of a pixel array. For example, the photodetector may be implemented as a complementary metal-oxide semiconductor (CMOS) sensor or a charge-coupled device (CCD) sensor including multiple pixels (or sensor elements). Each pixel of the photodetector may be arranged in a direction perpendicular to a path of light incident from the alignment coupler, and a pixel which senses light may be changed depending on an incident angle of the incident light. This embodiment has been described with reference to FIGS. 7, 8A, and 8B.

According to various embodiments, in operation 1040, the electronic device may determine a position error of an augmented reality image incident on the user's eyes, based on a result of light detection by the photodetector. For example, when the photodetector is configured as a photo diode (e.g., FIG. 6), the photodetector may output an electrical signal corresponding to the size (or area) of incident light, and the processor may determine an error in an optical system and a resulting position error of the augmented reality image, based on the received electrical signal. When the photodetector is configured as an active sensor in the form of a pixel array (e.g., FIG. 7, FIG. 8A, and FIG. 8B), the photodetector may output an electrical signal including information of a pixel which has detected light to the processor, and the processor may determine the position error of the augmented reality image, based on the identified pixel position.

According to various embodiments, in operation 1050, the electronic device may identify whether the determined position error is greater than or equal to a first reference value. When the position error is less than the first reference value, the electronic device may determine that the error in the optical system is minor, and in operation 1080, the electronic device may generate and output an augmented reality image without going through a separate alignment process.

According to various embodiments, in operation 1060, when the position error is greater than or equal to the first reference value (yes in 1050), the electronic device may identify whether the determined position error is greater than or equal to a second reference value greater than the first reference value. When the position error is greater than or equal to the first reference value and less than the second reference value, the electronic device may determine that the error is a correctable level of error, and in operation 1070, the electronic device may compensate for a position of light incident on the wave guide from the display, and in operation 1080, the electronic device may output a compensated augmented reality image.

According to an embodiment, the electronic device may generate a compensated augmented reality image obtained by shifting pixel data of the augmented reality image, and output the compensated augmented reality image through the display. According to an embodiment, the electronic device may adjust an angle at which light output from the display is incident on the wave guide by adjusting an angle or a position of the display by a conversion motor, based on the position error of the augmented reality image.

According to various embodiments, when the position error is greater than or equal to the second reference value, in operation 1090, since it is difficult to display the augmented reality image in a correct position by a compensation method, the electronic device may display, through the display, a user notification including information indicating that repair of the optical system is required without performing compensation.

In an augmented reality image compensation method of an electronic device 400 according to various embodiments of the disclosure, the electronic device 400 may include a display 410 configured to output light including an augmented reality image, a wave guide 420 configured to transmit light output from the display 410 toward a user's eyes, at least one alignment coupler disposed on an optical path formed by the wave guide 420, and configured to diffract at least a part of incident light at a predetermined angle, and a photodetector 450 configured to detect at least a part of light diffracted by the alignment coupler.

According to various example embodiments, the method may include identifying information related to light detected by the photodetector, determining a position error of an augmented reality image incident on the user's eyes, based on the identified information, and compensating for a position of light incident on the wave guide from the display in order to compensate for the determined position error.

According to various example embodiments, the electronic device may further include an in-coupler configured to diffract at least a part of light output from the display into the wave guide, and an out-coupler configured to diffract at least a part of light transmitted within the wave guide toward the user's eyes.

According to various example embodiments, the alignment coupler may be disposed on an optical path formed by the in-coupler and the out-coupler.

According to various example embodiments, the determining the position error of the augmented reality image may include identifying a current value corresponding to the amount of light detected by the photodetector, and determining the position error of the augmented reality image, based on the identified current value.

According to various example embodiments, the photodetector may include multiple pixels, and the determining the position error of the augmented reality image may include identifying at least one pixel among the multiple pixels that detects light diffracted by the alignment coupler, and determining the position error of the augmented reality image, based on the identified at least one pixel.

According to various example embodiments, the compensating for the position of the light incident on the wave guide may include outputting, through the display, a compensated augmented reality image obtained by shifting pixel data of the augmented reality image, based on the determined position error.

According to various example embodiments, the electronic device may further include a conversion motor configured to adjust an angle between the display and the wave guide.

According to various example embodiments, the compensating for the position of the light incident on the wave guide may include, based on the determined position error, by the conversion motor, adjusting an angle of the display and adjusting an angle at which light output from the display is incident on the wave guide.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display configured to output light including an augmented reality image;
a wave guide configured to transmit light output from the display toward a user's eyes;
at least one alignment coupler disposed on an optical path formed by the wave guide, and configured to diffract at least a part of incident light at a specified angle;
a photodetector configured to detect at least a part of light diffracted by the alignment coupler;
memory; and
at least one processor, comprising processing circuitry, operatively connected to the display, the photodetector, and the memory,
wherein the memory stores instructions executable by at least one processor individually and/or collectively, when executed, cause the electronic device to:
identify information related to light detected by the photodetector;
determine a position error of an augmented reality image incident on the user's eyes, based on the identified information; and
compensate for a position of light incident on the wave guide from the display to compensate for the determined position error.

2. The electronic device of claim 1, further comprising:
an in-coupler configured to diffract at least a part of light output from the display into the wave guide; and
an out-coupler configured to diffract at least a part of light transmitted within the wave guide toward the user's eyes,
wherein the alignment coupler is disposed on an optical path formed by the in-coupler and the out-coupler.

3. The electronic device of claim 1, wherein the wave guide comprises a first surface facing the display and a second surface opposite the first surface,
wherein the alignment coupler comprises a reflective diffractive grating disposed on the first surface of the wave guide, and
wherein the photodetector is disposed on the second surface of the wave guide.

4. The electronic device of claim 1, wherein the wave guide comprises a first surface facing the display and a second surface opposite the first surface,
wherein the alignment coupler comprises a transmissive diffractive grating disposed on the first surface of the wave guide, and
wherein the photodetector is disposed on an opposite side of the wave guide from the alignment coupler.

5. The electronic device of claim 1, wherein the photodetector is disposed to be spaced apart from the wave guide by a specified gap.

6. The electronic device of claim 1, wherein, based on there being no position error, the photodetector is disposed in a direction in which light diffracted by the alignment coupler is incident substantially vertically.

7. The electronic device of claim 1, further comprising:
an in-coupler configured to diffract at least a part of light output from the display into the wave guide;
an out-coupler configured to diffract at least a part of light transmitted within the wave guide toward the user's eyes; and
a mid-coupler configured to diffract at least a part of light diffracted by the in-coupler toward the out-coupler,
wherein the at least one alignment coupler comprises at least one of a first alignment coupler disposed in a traveling direction of light that is not diffracted by the mid-coupler, or a second alignment coupler disposed in a traveling direction of light that is not diffracted by the out-coupler.

8. The electronic device of claim 1, wherein the memory stores instructions cause the electronic device to:
identify a current value corresponding to an amount of light detected by the photodetector; and
determine a position error of the augmented reality image, based on the identified current value.

9. The electronic device of claim 1, wherein the photodetector comprises multiple pixels, and
wherein the memory stores instructions cause the electronic device to:
identify at least one pixel configured to detect light diffracted by the alignment coupler among the multiple pixels; and
determine a position error of the augmented reality image, based on the identified at least one pixel.

10. The electronic device of claim 1, wherein the memory stores instructions cause the electronic device to:
output, through the display, a compensated augmented reality image obtained by shifting pixel data of the augmented reality image, based on the determined position error.

11. The electronic device of claim 1, further comprising a conversion motor configured to adjust an angle between the display and the wave guide,
wherein at least one processor, individually and/or collectively, is configured to control the conversion motor to, based on the determined position error, adjust an angle of the display and adjust an angle at which light output from the display is incident on the wave guide.

12. The electronic device of claim 1, wherein the memory stores instructions cause the electronic device to:
based on the determined position error being greater than or equal to a first reference value, compensate for the position of the light incident on the wave guide from the display; and
based on the determined position error being greater than or equal to a second reference value greater than the first reference value, output a notification indicating the position error.

13. The electronic device of claim 1, wherein the memory stores instructions cause the electronic device to:
based on an input received after compensating for the position of the light incident on the wave guide from the display, output the augmented reality image according to a result of the compensation, or restore the output of the augmented reality image to the image before the compensation.

14. The electronic device of claim 1, wherein the electronic device includes augmented-reality (AR) glasses configured to display the augmented reality image by overlapping the augmented reality image with real-world information.

15. An augmented reality image compensation method of an electronic device, wherein the electronic device comprises:
a display configured to output light including an augmented reality image; a wave guide configured to transmit light output from the display toward a user's eyes; at least one alignment coupler disposed on an optical path formed by the wave guide, and configured to diffract at least a part of incident light at a predetermined angle; and a photodetector configured to detect at least a part of light diffracted by the alignment coupler,
wherein the method comprises:
identifying information related to light detected by the photodetector;
determining a position error of an augmented reality image incident on a user's eyes, based on the identified information; and
compensating for a position of light incident on the wave guide from the display to compensate for the determined position error.

16. The method of claim 15, wherein the electronic device further comprises an in-coupler configured to diffract at least a part of light output from the display into the wave guide, and an out-coupler configured to diffract at least a part of light transmitted within the wave guide toward the user's eyes, and
the alignment coupler is disposed on an optical path formed by the in-coupler and the out-coupler.

17. The method of claim 15, wherein the determining the position error of the augmented reality image comprises identifying a current value corresponding to the amount of light detected by the photodetector, and
determining the position error of the augmented reality image, based on the identified current value.

18. The method of claim 15, wherein the photodetector comprises multiple pixels, and
the determining the position error of the augmented reality image comprises:
identifying at least one pixel among the multiple pixels that detects light diffracted by the alignment coupler, and
determining the position error of the augmented reality image, based on the identified at least one pixel.

19. The method of claim 15, wherein the compensating for the position of the light incident on the wave guide comprises outputting, through the display, a compensated augmented reality image obtained by shifting pixel data of the augmented reality image, based on the determined position error.

20. The method of claim 15, wherein the electronic device further comprises a conversion motor configured to adjust an angle between the display and the wave guide, and
the compensating for the position of the light incident on the wave guide comprises, based on the determined position error, by the conversion motor, adjusting an angle of the display and adjusting an angle at which light output from the display is incident on the wave guide.
